(19) United States
(12) Patent Application Publication
(10) Pub. No.: US 2009/0189805 A1
(43) Pub. Date: Jul. 30, 2009

(54) Low Cost Instant RTK Positioning System and Method

(76) Inventor: Bruno Sauriol, Montreal (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/020,031

(22) Filed: Jan. 25, 2008

(51) Int. Cl. G01S 5/14

(52) U.S. Cl. 342/357.03; 342/357.04

(57) ABSTRACT

A low cost instant Real-Time Kinematic (RTK) positioning system and method are disclosed. The system comprises at least the following elements: a base station and a rover unit, each equipped with a Satellite Positioning System (SATPS) receiver and a generally license-free radio link transceiver. Such system has the distinctive feature of having no carrier integer cycle ambiguity to solve, thus allowing low cost single frequency SATPS receivers to be used for instant centimetre level relative positioning.

### CROSS-REFERENCE TO RELATED APPLICATIONS

There are no cross-related applications.

### FIELD OF THE INVENTION

The present invention principally relates to surveying, but also extends, and does not limit, to high-precision navigation, searching, marking and distance measuring using satellite navigational equipment.

### BACKGROUND OF THE INVENTION

A Satellite Positioning System (hereinafter “SATPS”) such as, but not limited to, the Global Navigation System (GPS), the Global Navigation Satellite System (GLONASS) and the yet to be deployed Galileo system in Europe and Compass system in China, generally allows civilian users world-wide to position themselves free of charge. Those civilian users usually benefit of an absolute positioning precision of about 2 to 20 meters using SATPS. It is also possible to achieve decimetre to meter levels of precision by relative positioning techniques, better known as Differential GPS (DGPS).

Both absolute and relative positioning techniques rely on the measurement of the ranging codes transmitted in the SATPS satellites signals. Those codes usually have a wavelength of tens of meters to hundred of meters, resulting in relatively coarse measurements. Instead of using the code phase, it is however possible to precisely measure the signals carrier phase. Because the carrier wavelength is much smaller than the code wavelength (about 19 centimetres for the GPS L1 carrier, which frequency is 1545.75 MHz), centimetre precision can thus be achieved by carrier phase-based relative positioning.

Carrier phase-based relative positioning in real-time is also known as “Real-Time Kinematic satellite navigation” (hereinafter “RTK”). Because it operates in real-time, RTK requires a radio frequency transmitter and receiver to send measurements from a base station SATPS receiver (a ground fixed receiver used as a reference point) to a rover unit (the position measurement unit itself). RTK has been used for many years for surveying but still suffers from many problems which prevent it from being used in consumer devices.

The first and main problem of RTK is that integer carrier cycle ambiguities have to be solved. In opposition to the ranging codes, it is actually impossible to distinguish between one carrier cycle and another. Thus, it is necessary to test multiple integer carrier cycle combinations before obtaining a centimetre level position fix, which usually takes several minutes with low-cost equipment. For this reason, new methods have been developed in order to accelerate the integer ambiguity solving process. However, such methods often rely on expensive high-precision, multiple frequencies, receivers that are unaffordable to most consumers.

The second problem of RTK is that bulky and heavy equipment has to be carried out. The equipment is also complex as every RTK unit usually has separate radio transceivers, SATPS receivers, antennas, handheld user interfaces and battery packs, plus a tripod or a survey pole. For those reasons, RTK is generally restrained to trained professionals. Lighter and smaller equipment would thus simplify the use of RTK.

The third problem of RTK is that powerful radio transmitters are usually used to transmit data from a base to a rover unit. Thus, specific frequencies must be used, requiring a special permit to operate RTK equipment. However, such expensive radios might not be necessary for short baselines (that is the distance vector from the base to the rover). Cheaper and less powerful radios operating at open frequency ranges would help to reduce the price and the size of RTK receivers.

### SUMMARY OF THE INVENTION

The present invention describes a low cost instant RTK system and method to solve the above problems. The system generally consists of a base station and a rover unit, both incorporating a preferably low cost SATPS receiver and a preferably low cost, low power and license-free radio transmitter and/or receiver in order to reduce the overall price and weight. This also means smaller components, which could help in the integration of the base station and the rover unit into smaller and more compact devices.

The disclosed invention generally targets short baseline measurements. Short baseline measurements are usually measurements of varying distances which vary according to the conditions in which the system is deployed (e.g. open rural area vs. dense urban area). Typically, but not exclusively, short baseline measurements vary between ˜0 and ˜2 km. The targeting of short baseline measurements has allowed the development of a new method to instantly remove the carrier cycle ambiguities. This method consists of bringing into close proximity the base and rover SATPS antennas on start-up. By placing the center of phase of the antennas close enough from one to the other (closer than one carrier wavelength), then no integer ambiguity exists. Therefore, there is no need of using complex ambiguity solving algorithms or high precision, multi-frequencies, SATPS receivers. Low cost single frequency receivers could be directly used instead.

Another method also includes backup points in order to remove the integer ambiguities once the rover is away from the base. Those backup points, previously stored by the rover, allow the RTK algorithm to instantly resume in case of SATPS signal outage or cycle slips. Therefore, there is no need to go back to the base every time the signals are lost or corrupted.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a simplified block diagram illustrating one embodiment of elements of the low cost RTK system in accordance with the present invention.

FIG. 2 is a perspective view of one embodiment of the base station mounted onto a tripod and one embodiment of the rover unit placed in close proximity to that base in accordance with the present invention.

FIG. 3a is a simplified illustration of one embodiment of the rover unit located at a backup point in accordance with the present invention and FIG. 3b illustrates an alternate embodiment of the rover unit located at a backup point in accordance with the present invention.

FIG. 4 is a simplified flow diagram illustrating the proximity initialization process to be performed with respect to one embodiment of the low cost RTK system in accordance with the present invention.

FIG. 5 is a simplified flow diagram illustrating the remote initialization process to be performed with respect to one embodiment of the low cost RTK system in accordance with the present invention.

### DETAILED DESCRIPTION OF THE PREFERRED EMBODIMENT

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the invention. However, it will be apparent to one skilled in the art that the present invention may be practiced without these specific details. In other instances, well known methods, procedures, components and circuits have not been described in detail as not to unnecessarily obscure aspects of the present invention.

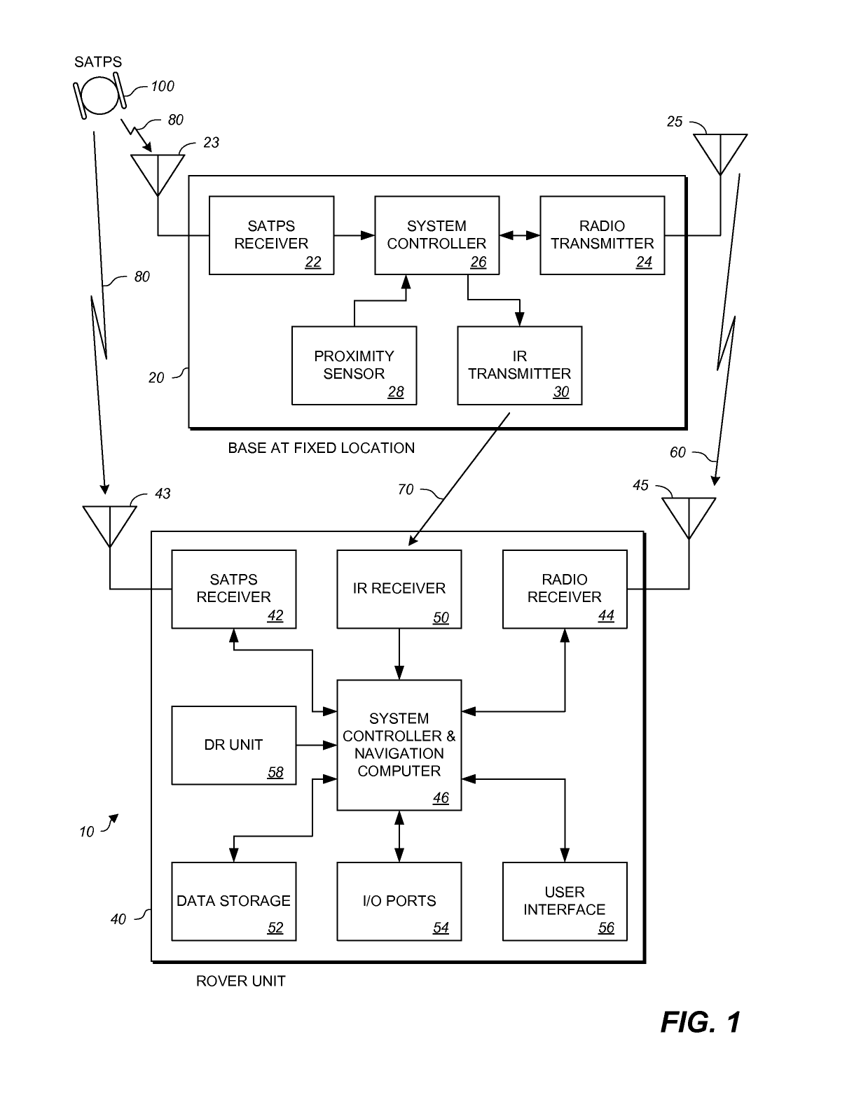

FIG. 1 depicts an exemplary embodiment of a low cost RTK system in accordance with the present invention. The system 10 includes a base station 20, a rover unit 40 and a radio link 60 between the base station and the rover unit.

The base 20 is generally located at a fixed position. The rover 40 is a moving device. The complete system 10 is designed to provide position fixes: (1) in real time, almost instantly, and (2) very precisely, that is with centimetre accuracy, after integer ambiguity is removed. Those position fixes represent the measurement of the baseline that is the distance vector from the base 20 to the rover 40.

Both the base 20 and the rover 40 include a SATPS receiver 22 and 42 respectively along with a SATPS antenna 23 and 43 respectively. Both base and rover SATPS antenna and receivers are designed to receive the satellite signals 80 emanating from a Satellite Positioning System (SATPS) 100.

The base 20 and rover 40 also include a radio transmitter 24 and receiver 44 respectively, along with a radio antenna 25 and 45 respectively. The main purpose of those radio transmitter, receiver and antennas is to transfer, in real time, the measurements made by the base SATPS receiver 22 to the rover unit 40. One has to note that such data transfer task from the base 20 to the rover 40 could also be accomplished by means other than radio communications. For example, optical (e.g. laser), Infra-Red (IR) or sonic communication devices could be used to transfer the base SATPS receiver measurements to the rover; the present invention is not so limited.

The base 20 has a system controller 26, which main purpose is to relay the measurements from the base SATPS receiver 22 to the base radio transmitter 24. Another task of this controller is to verify the close proximity of the rover unit 40 to the base. This is typically achieved by using a proximity sensor 28. The proximity sensor 28 can be of various types: magnetic, IR, sonic, radio, optical or contact sensitive. The proximity sensing could also be directly done via an input from an operator or a user. The latter case will be further referred to as proximity detection means based on an operator or a user intervention (e.g. indication of proximity via an actuator or a voice command). If rover proximity is detected, the proximity sensor (or actuator or voice command device) sends a signal to the base system controller 26, which in turn transmits the base radio channel number (a radio channel specifically used by the base radio transmitter 24) to the rover, preferably, but not exclusively, with the use of an Infra-Red (IR) transmitter 30. One has to note that every single base station 20 has a different radio channel number, thus allowing multiple base stations to operate in a same area without interfering with each other.

If the rover 40 is close enough from the base 20, it receives the base radio channel number through an IR communication link 70, thanks to an IR receiver 50. This IR receiver directly sends the base radio channel number to the rover system controller and navigation computer 46. The controller and navigation computer then tunes the rover radio receiver 44 to the right channel in order to receive the base SATPS receiver 22 measurements. Because the base 20 and the rover 40 must be in close proximity at this moment, no integer ambiguity exists (explained below) and the rover system controller and navigation computer can immediately start computing a RTK navigation solution. This RTK navigation solution can be directly stored in a data storage device 52 or transferred, for instance to a computer, through Input/Output (I/O) ports 54. The RTK navigation solution could also be examined and manipulated in real time by a user, thanks to an appropriate user interface 56.

The rover unit 40 can also incorporate a dead-reckoning (DR) unit 58. This DR unit has the purpose of increasing the precision of the RTK navigation solution as well as increasing its robustness.

One has to note that the IR transmitter 30, the IR receiver 50 and the IR communication link 70 stated above have been chosen with the sole purpose of explaining the present invention. Therefore, those transmitter, receiver and communication link could also be radio (preferably license-free), optical or sonic transmitters, receivers and communication links; the present invention is not so limited.

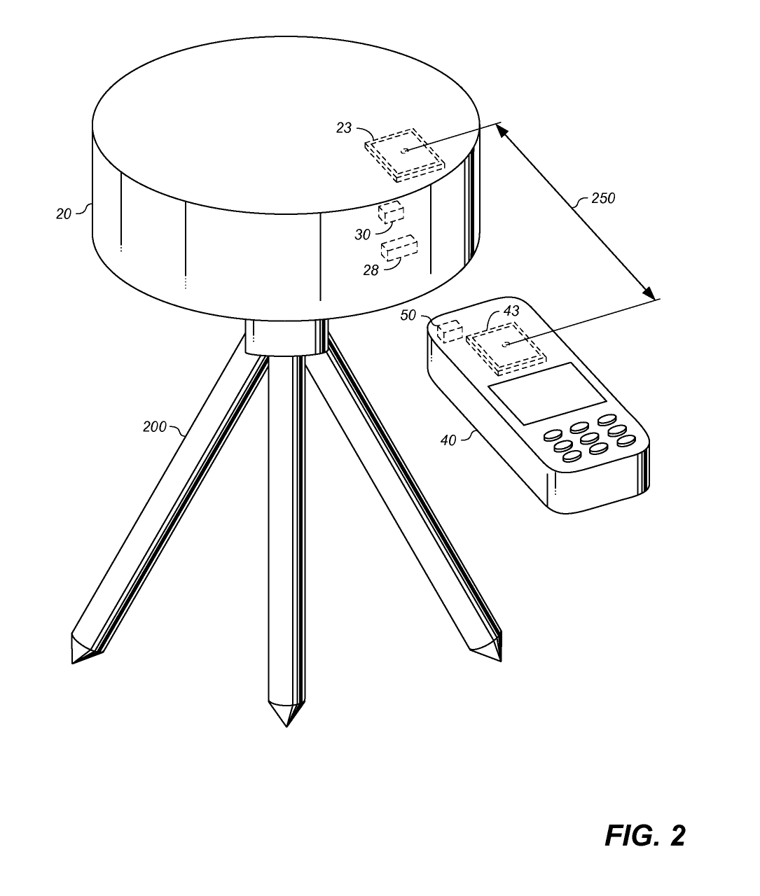

FIG. 2 shows a perspective view of the base 20 and rover 40. The base is represented on a tripod 200 and the rover is represented as a handheld device. The base and rover antennas 23 and 43 respectively are represented as small enclosed patch antennas. Other forms of antennas such as, but not limited to, helical antennas, could also be used.

As FIG. 2 suggests, the base 20 and rover 40 are held in close proximity. As explained above, the base detects the rover by using its proximity sensor 28. The base then sends its channel number using an IR transmitter 30. This channel number is received by the rover thanks to an IR receiver 50. Traditionally, this process would be followed by the execution of an algorithm in order to solve the integer carrier cycle ambiguity. However, the present invention is designed so that the base and rover SATPS antennas 23 and 43 center of phase are spaced apart 250 by less than a SATPS signal carrier wavelength at that moment. In that particular case, no integer ambiguity exists. It is thus possible to proceed directly with a RTK solution without having to solve the ambiguities.

According to the second edition of “Understanding GPS: Principles and Application” by E. D. Kaplan, published by Artech House in 2006, the single difference (SD) observation equation for a single measurement of SATPS satellite p is:

SDₚ=φₚ+Nₚ+Sₚ+fτ (1)

where φₚ is the satellite p carrier phase measurement difference between the base and the rover, Nₚ is the SD integer ambiguity of satellite p, Sₚ is the phase noise of satellite p due to all sources (e.g., receivers, multipaths),f is the carrier frequency and τ is the clock bias between the base and the rover.

Because the base and rover SATPS receivers are running on two different clocks, it is difficult to anticipate the clock bias τ. For this reason, it is preferable to compute the double differences (DD). According once again to the second edition of “Understanding GPS: Principles and Application” by E. D. Kaplan, the DD observation equation for a single measurement of SATPS satellites p and q is:

DD_{pq}=φ_{pq}+N_{pq}+S_{pq} (2)

where φ_{pq}=φₚ−φ_{q}, Nₚ is the DD integer ambiguity of satellites p and q and S_{pq} is the DD phase noise of satellites p and q due to all sources.

By placing the center of phase of the base and rover SATPS antennas in close proximity (this is closer than one SATPS signal carrier wavelength), we can suppose a near-zero baseline, thus DD_{pq}≈0. It is then possible to directly remove the integer ambiguity by computing (the noise term is dropped to simplify the expression):

N_{pq}=FIX(−φ_{pq}) (3)

where FIX is an operator that rounds to the nearest integer toward zero.

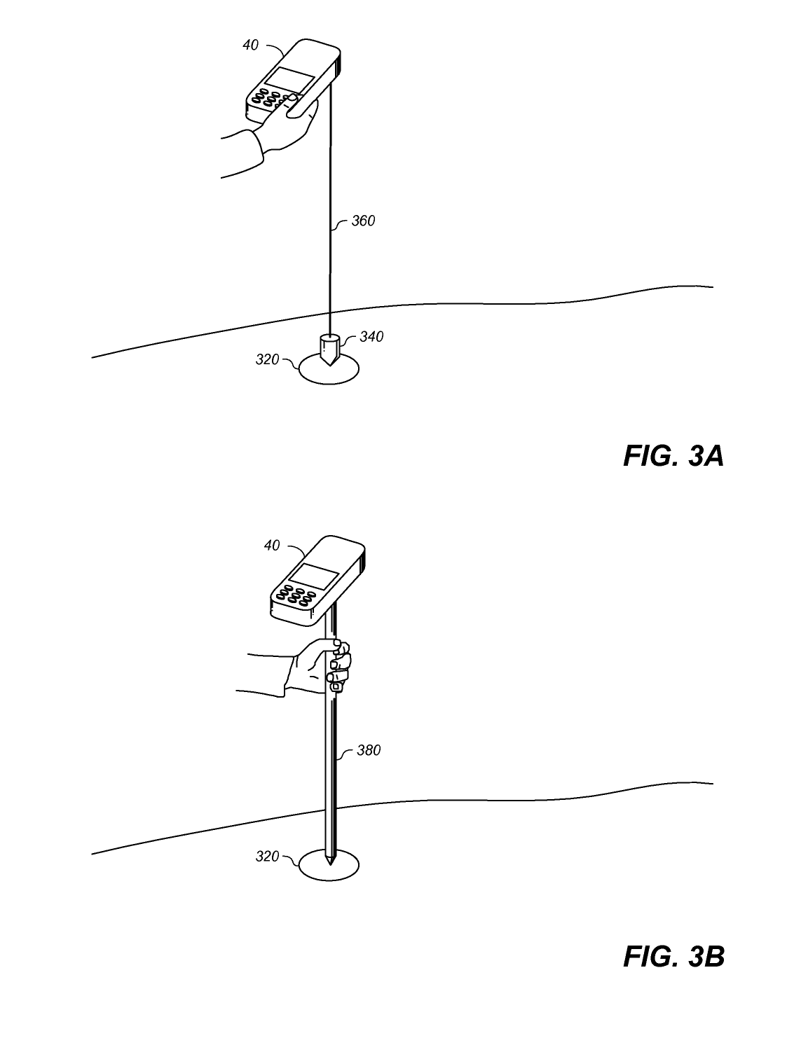

FIG. 3a shows an embodiment of the rover unit 40 located over a measurement point 320. A weight 340 is attached to the rover by a chain, a cable, a cord or a piece of string 360 in order to precisely indicate the location of the measurement point 320.

FIG. 3b shows another embodiment of the rover unit 40 located over a measurement point 320. A pole 380 is attached to the rover in order to precisely indicate the location of the measurement point 320.

If the integer ambiguity is removed, it is then possible for the rover 40 to store the measurement point 320 coordinates with centimetre accuracy. Suppose that the SATPS signals were lost, corrupted, or that carrier cycles slips could not be repaired, integer ambiguity would have to be removed once again. By previously storing a backup point, that is a measurement point 320, one could directly go back to that backup point to remotely and instantly remove the integer ambiguity. Therefore, this prevents the necessity to go back to the base every time a SATPS signal problem occurs. One could also directly measure, by using for example a laser or sonic range finder and a compass, a backup point coordinates relative to the base station and thus remotely and instantly remove the integer ambiguity from this newly measured backup point.

According to the second edition of “Understanding GPS: Principles and Application” by E. D. Kaplan, published by Artech House in 2006, the DD computation equation for a single measurement of 4 different SATPS satellites is:

$$[ \begin{matrix}{DD}_{cp 12} \\ {DD}_{cp 13} \\ {DD}_{cp 14}\end{matrix} ] = [ \begin{matrix}{e}_{12 x} & {e}_{12 y} & {e}_{12 z} \\ {e}_{13 x} & {e}_{13 y} & {e}_{13 z} \\ {e}_{14 x} & {e}_{14 y} & {e}_{14 z}\end{matrix} ] [ \begin{matrix}{b}_{x} \\ {b}_{y} \\ {b}_{z}\end{matrix} ] + [ \begin{matrix}{N}_{12} \\ {N}_{13} \\ {N}_{14}\end{matrix} ] λ \qquad ( 4 )$$

where DD_{cppq} is the carrier phase measurements double difference of satellites p and q (previously referred to as φ_{pq}), e_{pqx}, e_{pqy} and e_{pqz} are the line of sight differences between satellites p and q on all three axis, that is x, y and z, bₓ, b_{y} and b_{z} are the baseline vector components on all three axis, N_{pq} are the double differences integer ambiguity and λ is the SATPS signal carrier wavelength.

By moving back the rover to a backup point, one knows precisely the baseline vector components as they were previously stored by the rover or precisely measured at that moment. Moreover, the line of sight matrix can be computed from one of the SATPS receivers coarse position fixes. Therefore it is possible to remotely remove the integer ambiguity by manipulating equation (4):

$$[ \begin{matrix}{N}_{12} \\ {N}_{13} \\ {N}_{14}\end{matrix} ] = [ \begin{matrix}{DD}_{cp 12} \\ {DD}_{cp 13} \\ {DD}_{cp 14}\end{matrix} ] {λ}^{- 1} - [ \begin{matrix}{e}_{12 x} & {e}_{12 y} & {e}_{12 z} \\ {e}_{13 x} & {e}_{13 y} & {e}_{13 z} \\ {e}_{14 x} & {e}_{14 y} & {e}_{14 z}\end{matrix} ] [ \begin{matrix}{b}_{x} \\ {b}_{y} \\ {b}_{z}\end{matrix} ] {λ}^{- 1} \qquad ( 5 )$$

Equation (5) can finally be expressed as a matrix equation:

N=FIX{(DD_{cp}−E·B)λ⁻¹} (6)

where N is the integer ambiguity vector, DD_{cp} is the carrier phase measurements double difference vector, E is the line of sight matrix, B is the baseline vector, X is the SATPS signal carrier wavelength and FIX is an operator that rounds each elements of a vector to the nearest integer toward zero.

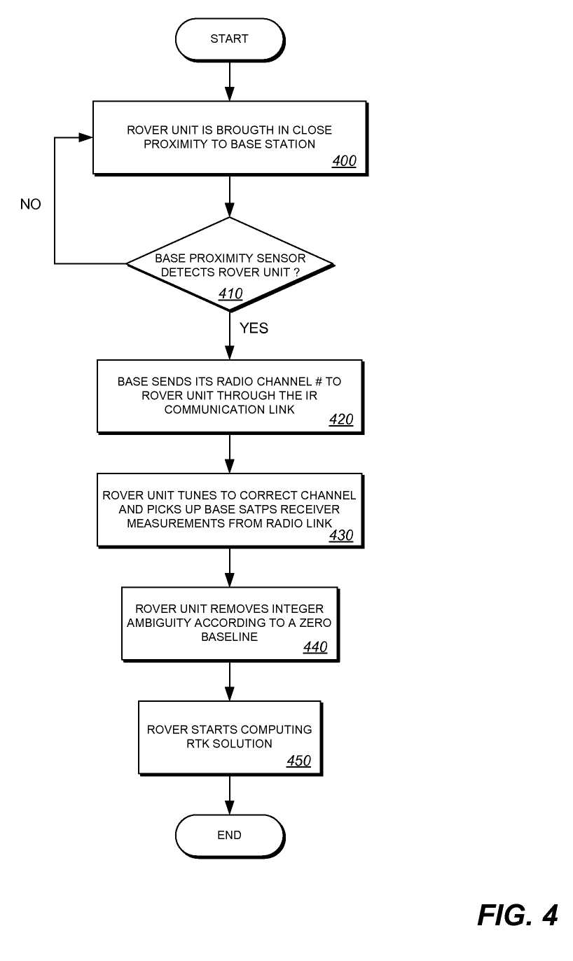

FIG. 4 is a simplified flow diagram. It summarizes the proximity initialization process, which is the process explained above to remove the integer ambiguity by placing in close proximity the base and the rover.

The proximity initialization process begins by bringing the base and the rover into close proximity 400. If the base proximity sensor detects the rover, the process may continue, otherwise previous step must be retried 410. Afterward, the base sends its radio channel number through the IR communication link 420. The rover then tunes to the correct radio channel and picks up the base SATPS receiver measurements from the radio link 430. This allows the rover to instantly remove the integer ambiguity according to a zero baseline 440 as explained above. Finally, the rover can start computing a RTK solution 450, which can be further processed, stored or displayed in real time by means of a user interface.

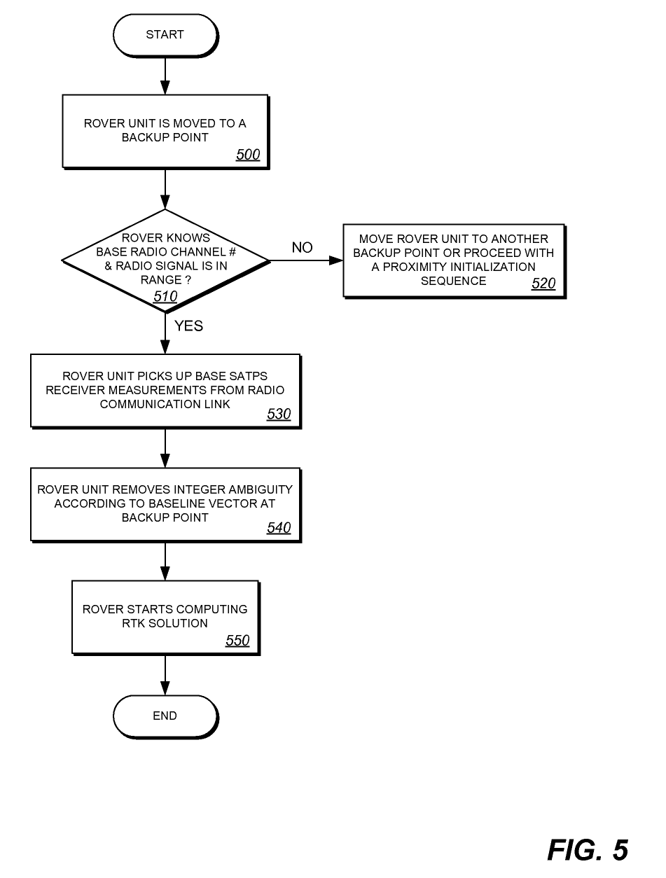

FIG. 5 is also a simplified flow diagram. It summarizes the remote initialization process, which is the process explained above to remove the integer ambiguity by moving the rover to a backup point.

The remote initialization process begins by moving the rover to a backup point 500. If the rover already knows the base radio channel number, which mean that a proximity initialization has been already performed, and that the base radio signal is detected and is in range, then the process may continue 510. Otherwise, the rover must be moved again in order to detect the base signal, or a proximity initialization must be performed 520. If the process is allowed to continue, the rover then picks up the base SATPS receiver measurements from the radio link 530. This allows the rover to instantly remove the integer ambiguity according to the baseline vector at backup point 540 as explained above. Finally, the rover can start computing a RTK solution 550, which can be further processed, stored or displayed in real-time by mean of a user interface.

Because the present invention can achieve instant centimetre precision without the need for complex signal processing and integer ambiguities resolving, low cost, single frequency, SATPS receivers can be used. Because the present invention also targets short baseline measurements, that is, for example, measurements of distance in the order of 2 km or less depending on the type of area (e.g. urban, rural, etc.) in which the system is deployed, the radio transmitter and receiver can as well be chosen to be low cost and low power. For convenience, such radio transmitter and receiver can also be chosen to operate on license-free frequency bands. This means important cost reductions of the present invention compared to the prior art. It also means weight, size and complexity reduction.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A low cost Real-Time Kinematic (RTK) system for use with at least one Satellite Positioning System (SATPS) adapted to broadcast SATPS satellite signals, said RTK system comprising:
a base station comprising a base SATPS satellite navigation receiver and a base SATPS satellite antenna, said base station being placed in a fixed location, said base station configured to receive said SATPS satellite signals from said SATPS satellite system, configured to perform base carrier phase measurements on said SATPS satellite signals, and configured to transmit results of said base carrier phase measurements;
a rover unit comprising a rover SATPS satellite navigation receiver and a rover SATPS satellite antenna, said rover unit configured to receive said SATPS satellite signals from said SATPS satellite system, configured to perform rover carrier phase measurements on said SATPS satellite signals and configured to receive results of said base carrier phase measurements from said base station;
a carrier phase navigation processor configured to determine said rover unit position relative to said base station using said base carrier phase measurements and said rover carrier phase measurements; and
a proximity detection means for informing said system that the center of phase of said base SATPS satellite antenna is horizontally located at a distance on the order of or inferior to one SATPS satellite signal carrier wavelength from the center of phase of said rover SATPS satellite antenna.

2) The system of claim 1, wherein said base SATPS satellite navigation receiver and said rover SATPS satellite navigation receiver are non-RTK SATPS receivers.

3) The system of claim 1, wherein said base SATPS satellite navigation receiver and said rover SATPS satellite navigation receiver are single frequency SATPS receivers.

4) The system of claim 1, wherein said carrier phase navigation processor computes said rover unit position substantially in real time.

5) The system of claim 1, wherein said proximity detection means is a magnetic proximity detection sensor or a Radio Frequency (RF) proximity detection sensor or an Infra-Red (IR) proximity detection sensor or a sonic proximity detection sensor or an optical proximity detection sensor or a contact sensitive proximity detection sensor or a RF IDentification (RFID) system or device.

6) The system of claim 1, wherein said proximity detection means is responsive to an input from a user of said system.

7) The system of claim 1, wherein said base SATPS satellite antenna and said rover SATPS satellite antenna are patch and/or helical antennas.

8) The system of claim 1, further comprising a weight to point to a location to be measured by said rover unit, wherein said weight is attached to said rover unit.

9) The system of claim 8, wherein said weight is attached to said rover unit by a chain or a cable or a cord or a string.

10) The system of claim 1, further comprising a pole attached to said rover unit.

11) The system of claim 1, further comprising a Dead-Reckoning (DR) unit connected to said rover unit.

12) The system of claim 1, wherein said system comprises one or multiple base stations and/or one or multiple rover units.

13) The system of claim 1, further comprising:
a transmitter connected to said base station, said transmitter configured to transmit said base carrier phase measurements to said rover unit;
a receiver connected to said rover unit, said receiver configured to receive said base carrier phase measurements; and
a communication link between said base station and said rover unit for communicating said base carrier phase measurements from said base station to said rover unit.

14) The system of claim 13, wherein said transmitter and said receiver are radio communication devices or Infra-Red (IR) communication devices or optical communication devices or sonic communication devices.

15) The system of claim 13, further comprising:
a secondary transmitter connected to said base station, said secondary transmitter configured to transmit a base identification and/or channel number to said rover unit;
a secondary receiver connected to said rover unit, said secondary receiver configured to receive said base identification and/or channel number; and
a secondary communication link between said base station and said rover unit for communicating said base identification and/or channel number from said base station to said rover unit.

16) The system of claim 15, wherein said secondary transmitter and said secondary receiver are radio communication devices or Infra-Red (IR) communication devices or optical communication devices or sonic communication devices.

17) A method for proximity RTK integer carrier cycle ambiguity removal, said method comprising the steps of:
moving a rover unit comprising a rover SATPS satellite navigation receiver and a rover SATPS satellite antenna in proximity to a base station comprising a base SATPS satellite navigation receiver and a base SATPS satellite antenna, wherein the center of phase of said rover SATPS satellite antenna is horizontally located at a distance on the order of or inferior to one SATPS satellite signal carrier wavelength from the center of phase of said base SATPS satellite antenna;
receiving SATPS satellite signals from a SATPS satellite system by said base SATPS satellite navigation receiver, said base being placed in a fixed location;
performing carrier phase measurements at said base;
transmitting results of said carrier phase measurements from said base;
receiving, at said rover, results of said base carrier phase measurements;
receiving SATPS satellite signals from said SATPS satellite system by said rover SATPS satellite navigation receiver;
performing carrier phase measurements at said rover;
calculating Double-Difference (DD) carrier phase quantities by using said base carrier phase measurements and said rover carrier phase measurements;
evaluating integer carrier cycle ambiguities by using said DD carrier phase quantities and considering zero horizontal baseline vector components and a zero or known vertical baseline vector component from said base to said rover unit;

18) A method for remote RTK integer carrier cycle ambiguity removal, said method comprising the steps of:
moving a rover unit comprising a rover SATPS satellite navigation receiver to an especially identified backup location, wherein baseline vector components from a base station to said backup location are precisely known and wherein said base station comprises a base SATPS satellite navigation receiver;
receiving SATPS satellite signals from a SATPS satellite system by said base SATPS satellite navigation receiver, said base being placed in a fixed location;
performing carrier phase measurements at said base;
transmitting results of said carrier phase measurements from said base;
receiving, at said rover, results of said base carrier phase measurements;
receiving SATPS satellite signals from said SATPS satellite system by said rover SATPS satellite navigation receiver;
performing carrier phase measurements at said rover;
calculating Double-Difference (DD) carrier phase quantities by using said base carrier phase measurements and said rover carrier phase measurements;
evaluating integer carrier cycle ambiguities by using said DD carrier phase quantities and said baseline known components of said backup location.

19) The method of claim 18, wherein all components of said baseline vector have been precisely determined prior to moving said rover unit to said backup location.

20) The method of claim 18, wherein all components of said baseline vector are precisely determined once said rover unit has been moved to said backup location and wherein means of determining said baseline vector components are not SATPS-based.
